(19) United States
(12) Patent Application Publication
(10) Pub. No.: US 2021/0064108 A1
(43) Pub. Date: Mar. 4, 2021

(54) INFORMATION PROCESSING SYSTEM

(71) Applicant: FUJITSU CLIENT COMPUTING LIMITED, Kanagawa (JP)

(72) Inventors: Masatoshi Kimura, Kawasaki (JP); Tomohiro Ishida, Kawasaki (JP); Yuki Kawama, Kawasaki (JP)

(73) Assignee: FUJITSU CLIENT COMPUTING LIMITED, Kanagawa (JP)

(21) Appl. No.: 16/939,593

(22) Filed: Jul. 27, 2020

(30) Foreign Application Priority Data
Sep. 4, 2019 (JP) 2019-161497

(51) Int. Cl. G06F 1/26; G06F 9/4401

(52) U.S. Cl. CPC G06F 1/26; G06F 9/4401

(57) ABSTRACT

An information processing system includes a first information processing device, second information processing devices, and a relay device. The second information processing devices each include a second connector connected to the relay device, and a first restarter that restarts the second information processing devices. The relay device communicably connects the first and second information processing devices and includes a power supply control unit for power supply to the first and second information processing devices during restart of the relay device, and a second restarter that restarts the relay device in response to detection of a communication failure. The first information processing device includes a hot pluggable, first connector connected to the relay device, a first detector that detects restart of the relay device, and an initializer that initializes settings relating to communications via the relay device in response to detection of the relay device by the first detector.

### CROSS-REFERENCE TO RELATED APPLICATIONS

This application is based upon and claims the benefit of priority from Japanese Patent Applications No. 2019-155024 and No. 2019-161497, both filed on Sep. 4, 2019, the entire contents of all of which are incorporated herein by reference.

### FIELD

Embodiments described herein relate to an information processing system.

### BACKGROUND

Conventionally, information processing systems have been proposed, which include a plurality of information processing devices to be connected to a relay device for data communications among the information processing devices.

Among such information processing systems, a single device incorporating both a plurality of information processing devices and a relay device is available, in which the information processing device communicates with one another via the relay device. Such an information processing system includes various types of information processing devices depending on data to process. In the information processing system, the relay device may be restarted at the time of occurrence of a failure. In such a case, the information processing devices in the information processing system are to perform processing such as initialization in response to the restart of the relay device, in order to continue mutual communications via the relay device.

However, the information processing system includes various kinds of information processing devices that support or do not support hot plugging (for example, hot plug detect (HPD)), therefore, the information processing system is to be perform processing suitable for the various kinds of information processing devices, at the time of restart of the relay device.

### SUMMARY

An information processing system according to one or more embodiments enables information processing devices to continuously communicate with one another via a relay device.

According to one or more embodiments, an information processing system includes a first information processing device including a first connector that supports hot plugging representing insertion and removal at the time of power-on; a plurality of second information processing devices; and a relay device that communicably connects the first information processing device and the second information processing devices. The second information processing devices each include second connector to be connected to the relay device, and a first restarter that restarts the second information processing devices. The relay device includes a power supply control unit that supplies power to the first information processing device and the second information processing devices during restart of the relay device, and a second restarter that restarts the relay device in response to detection of a communication failure. The first information processing device includes the first connector to be connected to the relay device, a first detector that detects the restarted relay device, and an initializer that initializes settings relating to communications via the relay device in response to detection of the relay device by the first detector.

### BRIEF DESCRIPTION OF THE DRAWINGS

FIG. 1 is a diagram illustrating an exemplary overall configuration of a computer with a built-in relay device according to one or more embodiments;

FIG. 2 is a diagram illustrating an exemplary hardware configuration of the respective elements of the computer with a built-in relay device;

FIG. 3 is a diagram illustrating an exemplary hardware configuration of a power supply control unit;

FIG. 4 is an explanatory diagram for an exemplary communication process among platforms in one or more embodiments;

FIG. 5 is a functional block diagram illustrating exemplary functions of the respective elements of the computer with a built-in relay device; and

FIG. 6 is a sequence diagram illustrating an exemplary recovery process in one or more embodiments.

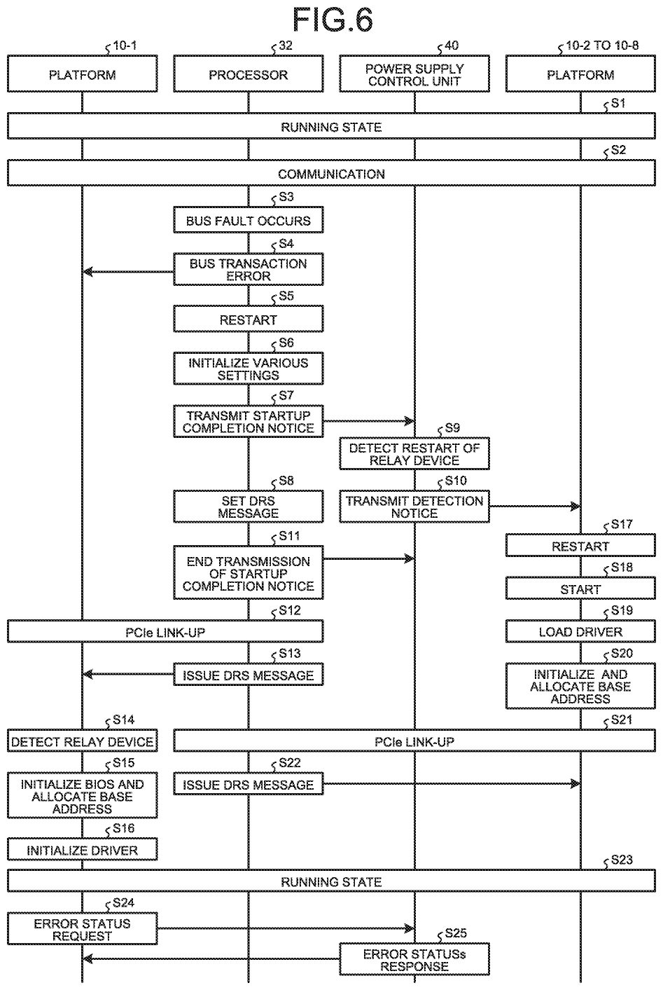

### DETAILED DESCRIPTION

Embodiments of an information processing system will be described below in detail with reference to the accompanying drawings. The embodiments are presented for illustrative purpose only and not intended to limit the scope of the present invention.

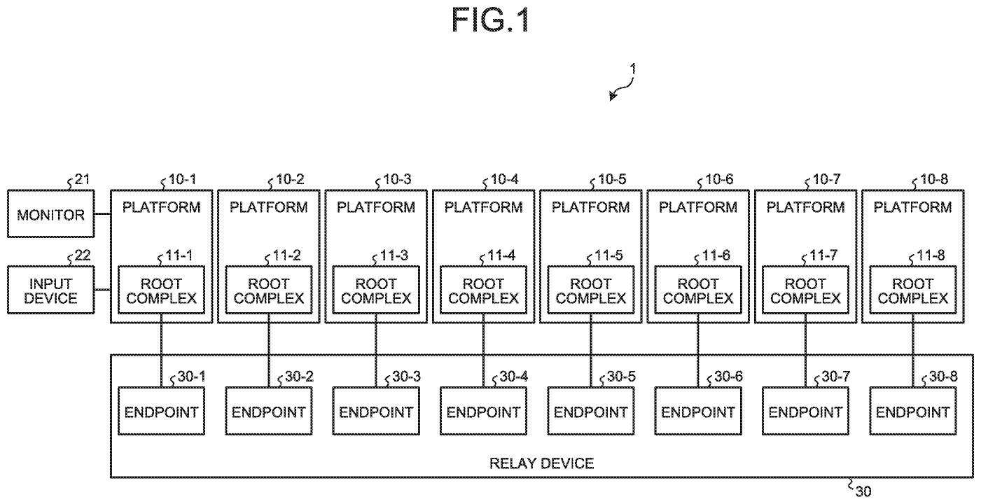

FIG. 1 is a diagram illustrating an exemplary overall configuration of a computer 1 including a built-in relay device according to one or more embodiments. The computer 1 with a built-in relay device serves as an information processing system and includes a platform 10-1, a plurality of platforms 10-2 to 10-8, and a relay device 30. The platform 10-1 includes an interface hot pluggable, that is, insertable and removable at the time of power-on. The platform 10-1 and the platforms 10-2 to 10-8 are communicably connected to one another via the relay device 30. As illustrated in FIG. 1, the computer 1 of one or more embodiments includes the platforms 10-1 to 10-8 and the relay device 30.

The platforms 10-1 to 10-8 are mutually connected via the relay device 30 in a communicable manner. The platforms 10-1 to 10-8 are inserted into, for example, slots on a board on which the relay device 30 is mounted. Any of the slots can be vacant with no platforms 10-1 to 10-8 inserted thereto. In the following, the platforms 10-1 to 10-8 will be referred to as platform or platforms 10 unless the platforms 10-1 to 10-8 are to be distinguished from each other.

The platform 10-1 is an exemplary first information processing device. The platform 10-1 serves as a main information processing device and controls the platforms 10-2 to 10-8 to execute various kinds of process.

The platform 10-1 is connected to a monitor 21 and an input device 22. The monitor 21 serves to display a variety of screens such as a liquid crystal display device. The input device 22 is exemplified by a keyboard and a mouse, and receives various operations.

The platforms 10-2 to 10-8 are an exemplary second information processing device. The platforms 10-2 to 10-8 serve as subordinate information processing devices and execute, for example, artificial intelligence (AI) inference and image processing in response to a request from the platform 10-1. The platforms 10-2 to 10-8 may include individually different functions, or every two or more of the platforms 10-2 to 10-8 may include different functions.

The platforms 10-1 to 10-8 include root complexes (RC) 11-1 to 11-8 operable as a host. In the following, the root complexes 11-1 to 11-8 will be referred to as root complex or root complexes 11 unless the root complexes 11-1 to 11-8 are to be distinguished from each other.

The root complexes 11 work to communicate with endpoints 30-1 to 30-8 of the relay device 30. That is, the platforms 10 and the relay device 30 are communicably connected to each other in compliance with a communications standard such as peripheral component interconnect express (PCIe). The platforms 10 and the relay device 30 may be mutually connected by another communication standard in addition to by PCIe.

The relay device 30 includes endpoints (EPs) 30-1 to 30-8. The relay device 30 relays communications among the platforms 10 including the root complexes 11 connected to the endpoints 30-1 to 30-8.

The endpoints 30-1 to 30-8 serve to execute communications with the root complexes 11 of the platforms 10. In the following, the endpoints 30-1 to 30-8 will be referred to as endpoint or endpoints 30 unless the endpoints 30-1 to 30-8 are to be distinguished from each other.

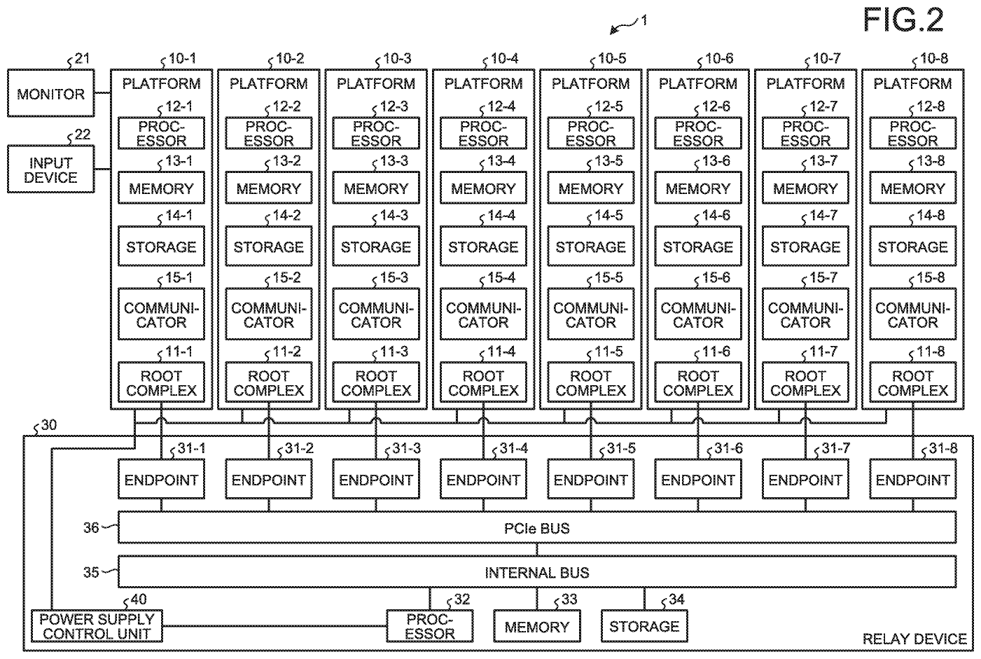

Next, the hardware configuration of the respective elements of the computer 1 with a built-in relay device will be described. FIG. 2 is a diagram illustrating an exemplary hardware configuration of the respective elements of the computer 1 with a built-in relay device. Herein, the hardware configuration of the platform 10-1 will be described as an example. The platforms 10-2 to 10-8 have the same configuration as the platform 10-1.

The platform 10-1 represents a computer which performs computations such as AI processing and image processing. The platform 10 includes the root complex 11-1, a processor 12-1, a memory 13-1, a storage 14-1, and a communicator 15-1, which are communicably connected to one another via a bus.

The processor 12-1 serves to control the entire platform 10-1. The processor 12-1 may be a multiprocessor. Further, the processor 12-1 may be, for example, any of a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). The processor 12 may be a combination of two or more of a CPU, a MPU, a GPU, a DSP, an ASIC, a PLD, and a FPGA. In the following, the processors 12-1 to 12-8 will be referred to as processor or processors 12 unless the processors 12-1 to 12-8 are to be distinguished from each other.

The memory 13-1 serves as a storage memory including a read only memory (ROM) and a random access memory (RAM). The ROM of the memory 13-1 contains various software programs and data for use on the programs. The processor 12 reads and executes the software programs from the memory 13-1 when appropriate. The RAM of the memory 13-1 is used as a primary storage memory or a working memory. In the following, the memories 13-1 to 13-8 will be referred to as memory or memories 13 unless the memories 13-1 to 13-8 are to be distinguished from each other.

The storage 14-1 represents a storage device such as a hard disk drive (HDD), a solid state drive (SSD), and a storage class memory (SCM), and stores various kinds of data. For example, the storage 14-1 stores various kinds of software programs. In the following, the storages 14-1 to 14-8 will be referred to as storage or storages 14 unless the storage 14-1 to 14-8 are to be distinguished from each other.

In the platform 10, the processor 12 executes the software programs stored in the memory 13 and the storage 14, thereby implementing various functions.

The various software programs may not be stored in the memory 13 or the storage 14. For example, the platform 10 may read and execute an information processing program from a storage medium readable by a medium reader. Examples of the storage medium readable by the platforms 10 include a portable recording medium such as a CD-ROM, a DVD disk, a universal serial bus (USB) memory, a semiconductor memory such as a flash memory, or a hard disk drive. Alternatively, the information processing program may be stored in a device connected to a public line, the Internet, a LAN, or the like, and the platform 10 may read and execute the information processing program from the device.

The communicator 15-1 serves as an interface for communicating with the power supply control unit 40. For example, the communicator 15-1 performs communications in compliance with a communication standard as an inter-integrated circuit (I2C). In the following, the communicators 15-1 to 15-8 will be referred to as communicator or communicators 15 unless the communicators 15-1 to 15-8 are to be distinguished from each other.

The relay device 30 will now be described. The relay device 30 includes the endpoints 30-1 to 30-8 corresponding to the respective platforms 10, a processor 32, a memory 33, a storage 34, an internal bus 35, a PCIe bus 36, and a power supply control unit 40. In the following, the endpoints 30-1 to 30-8 will be referred to as endpoint or endpoints 30 unless the endpoints 30-1 to 30-8 are to be distinguished from each other.

The endpoints 30 are provided for the respective platforms 10 and serve to transmit and receive data. For example, the endpoint 30 receives data from the connected platform 10 and transmits the received data to the endpoint 30 connected to another platform 10 being a destination via the PCIe bus 36.

The root complex 11 transmits data to another platform 10 by direct memory access (DMA) transfer, for example. The endpoint 30 receives data from another endpoint connected to the platform 10 being a transmission source via the PCIe bus 36, and transmits the received data to the connected platform 10.

The processor 32 serves to control the entire relay device 30. The processor 32 may be a multiprocessor. Further, the processor 32 may be, for example, any of a CPU, a MPU, a GPU, a DSP, an ASIC, a PLD, and a FPGA. The processor 32 may be a combination of two or more of a CPU, a MPU, a GPU, a DSP, an ASIC, a PLD, and a FPGA.

The memory 33 represents a storage device including a ROM and a RAM. The ROM contains various kinds of software programs and data for use on the software programs. The processor 32 reads and executes the programs from the memory 33. The RAM is used as a working memory.

The storage 34 represents a storage device such as a hard disk drive, a SSD, or a storage class memory, and stores various kinds of data. For example, the storage 34 stores various software programs.

The internal bus 35 communicably connects the processor 32, the memory 33, the storage 34, and the PCIe bus 36 to one another.

The PCIe bus 36 serves to communicably connect the endpoints 30 and the internal bus 35. That is, the PCIe bus 36 connects the endpoints 30 to one another to allow data transfer thereamong. The PCIe bus 36 is, for example, a bus compliant with the PCIe standard.

The power supply control unit 40 serves to control power supply to the platforms 10. The power supply control unit 40 represents, for example, an integrated circuit such as a microcomputer or a microcontroller. The power supply control unit 40 supplies power to the platforms 10 during restart of the relay device 30. The power supply control unit 40 is connected to the platform 10-1 and the processor 32 of the relay device 30.

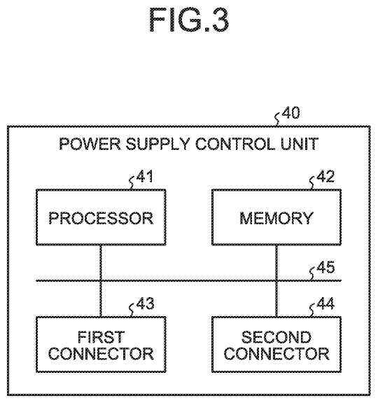

The hardware configuration of the power supply control unit 40 will now be described. FIG. 3 is a diagram illustrating an exemplary hardware configuration of the power supply control unit 40.

The power supply control unit 40 includes a processor 41, a memory 42, a first connector 43, and a second connector 44. The processor 41, the memory 42, the first connector 43, and the second connector 44 are communicably connected to one another via a bus 45.

The processor 41 serves to control the entire power supply control unit 40. The processor 41 may be a multiprocessor. The processor 41 may be, for example, any of a CPU, a MPU, a GPU, a DSP, an ASIC, a PLD, and a FPGA. Further, the processor 41 may be a combination of two or more of a CPU, a MPU, a GPU, a DSP, an ASIC, a PLD, and a FPGA.

The memory 42 represents a storage device including a ROM and a RAM. The ROM contains various kinds of software programs and data for use on the software programs. The processor 41 reads and executes the programs from the memory 42. Further, the RAM is used as a working memory.

The first connector 43 serves as an interface for connecting to the platform 10-1. The first connector 43 is exemplified by an I2C interface.

The second connector 44 serves as an interface for connecting to the processor 32 of the relay device 30. For example, the second connector 44 is connected to the processor 32 via a general-purpose input output (GPIO).

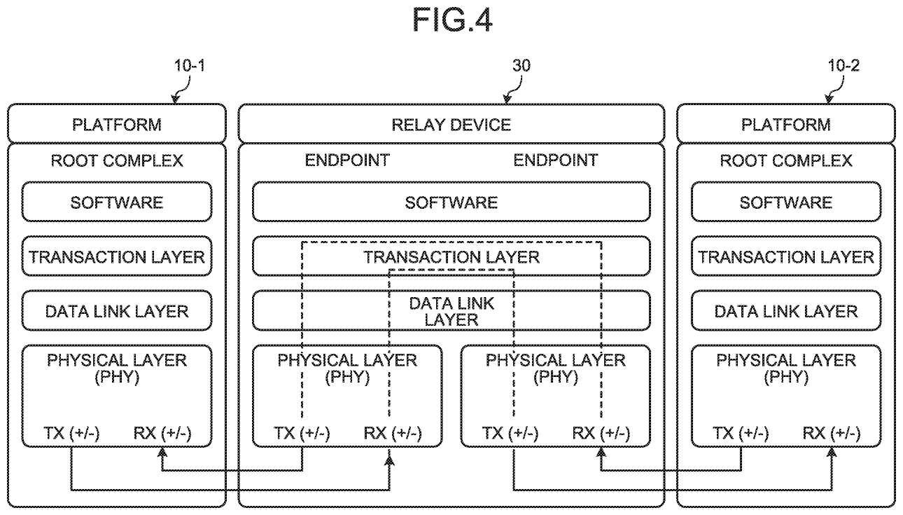

The following will describe an exemplary communication process between the platform 10-1 and the platform 10-2 both connected to the relay device 30. FIG. 4 illustrates an exemplary communication process among the platforms 10 according to one or more embodiments. Herein, the communication process between the platform 10-1 and the platform 10-2 will be described by way of example. The other platforms 10 perform communications in the same or like manner as the platform 10-1 and the platform 10-2.

As illustrated in FIG. 4, the computer 1 with a built-in relay device includes a layer structure defined by the PCIe standard, for example. The computer 1 with a built-in relay device establishes communications among the platforms 10 through the respective layers.

The platform 10-1 serving as a transmission source transfers software-designated data to the physical layer (PHY) of the relay device 30 through a transaction layer, a data link layer, and a physical layer (PHY).

The relay device 30 receives the data from the platform 10-1 being a transmission source and sends it to the transaction layer via the physical layer (PHY) and the data link layer. In the transaction layer the relay device 30 transfers the data to the endpoint 30 corresponding to the platform 10-2 being a destination by tunneling. The relay device 30 transfers the data to the physical layer (PHY) of the platform 10-2 being a destination through the transaction layer, the data link layer, and the physical layer (PHY). In this manner, the relay device 30 transfers the data from a transmission source, i.e., the platform 10-1 to a destination i.e., the platform 10-2 by tunneling the data between the endpoints 30.

In the platform 10-2 being a destination, the data is transferred to the software through the physical layer (PHY), the data link layer, and the transaction layer.

Unless the data transfer concentrates on one of the platforms 10 connected to the relay device 30, data is transferrable in parallel between any different combinations of the platforms 10.

To establish communication from the platform 10-2 and the platform 10-3 to the platform 10-1, for example, the relay device 30 performs communications with the platform 10-2 and the platform 10-3 in serial. While the different platforms 10 are in communication with each other and the communication is not concentrating on the specific platform 10, the relay device 30 performs communications among the platforms 10 in parallel.

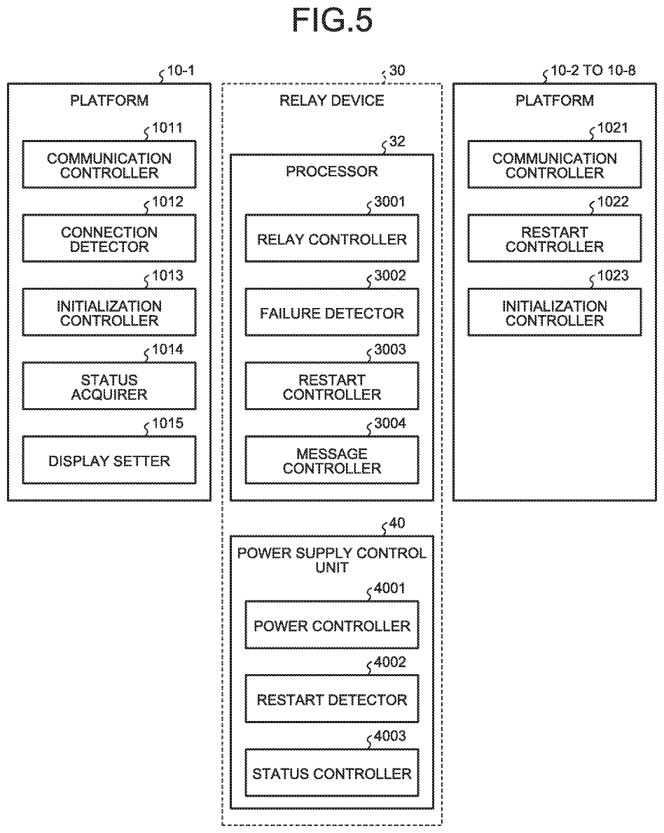

The following will describe the characteristic functions of the respective elements of the computer 1 with a built-in relay device of one or more embodiments. FIG. 5 is a functional block diagram illustrating an example of functions of the respective elements included in the computer 1 with a built-in relay device.

First, the platform 10-1 will be described.

The processor 12-1 of the platform 10-1 implements the functions illustrated in FIG. 5 by executing the programs stored in the memory 13-1 and the storage 14-1. Specifically, the processor 12-1 includes a communication controller 1011, a connection detector 1012, an initialization controller 1013, a status acquirer 1014, and a display setter 1015 as functional elements.

The communication controller 1011 is an exemplary first connector. The communication controller 1011 controls the root complex 11-1 to establish communications with the platforms 10-2 to 10-8 via the relay device 30. That is, the communication controller 1011 connects to the relay device 30. Then, the communication controller 1011 receives and transmits data from and to the relay device 30. The platform 10-1 is set as a device supporting HPD in system basic input output system (BIOS). That is, the communication controller 1011 is hot pluggable, that is, insertable or removable at the time of power-on. The platform 10-1 can thus communicate with the relay device 30 while inserted or removed at the time of power-on.

The connection detector 1012 is an exemplary first detector. The connection detector 1012 detects the connection of the relay device 30. The connection detector 1012 detects, for example, restart of the relay device 30 when it occurs.

The initialization controller 1013 is an exemplary initializer. In response to detection of the relay device 30 by the connection detector 1012, the initialization controller 1013 initializes settings as to the communications via the relay device 30. Specifically, the initialization controller 1013 initializes various settings in response to detection of the connection of the relay device 30 by BIOS. For example, the initialization controller 1013 initializes a base address register (BAR), an interrupt register, and other registers.

The status acquirer 1014 acquires information representing that the relay device 30 is restarted. Specifically, the status acquirer 1014 controls the communicator 15-1 to request the power supply control unit 40 to send an error status indicating the restart of the relay device 30. Then, the status acquirer 1014 acquires the error status, which is transmitted from the relay device 30 as a response.

The display setter 1015 is an exemplary setting changer. The display setter 1015 changes, to a non-display setting, a display for switching disconnection and connection between the platform 10 and the relay device 30. For example, in response to an operation input for disconnecting the platform 10 and the relay device 30 to “hardware removal” on the Windows (registered trademark) task bar, the connection between the platform 10 and the relay device 30 is disconnected. In this case, the disconnected platform 10 and relay device 30 cannot continue their communications. In this regard, the display setter 1015 switches the display to non-display by changing a registry value via an application programming interface (API) of a kernel-mode driver framework (KMDF) in a driver program.

The connection between the platform 10 and the relay device 30 can be also disconnected through “device and printer” of the Windows (registered trademark) control panel. In view of this, the display setter 1015 switches the display to the non-display by directly rewriting a registry value in an INF file. Thereby, the display setter 1015 prevents the connection between the platform 10 and the relay device 30 from being disconnected. That is, the display setter 1015 enables the platforms 10 to continue their communications via the relay device 30.

The relay device 30 will now be described.

The processor 32 of the relay device 30 implements the functions illustrated in FIG. 5 by executing the programs stored in the memory 33 and the storage 34. Specifically, the processor 32 includes a relay controller 3001, a failure detector 3002, a restart controller 3003, and a message controller 3004 as functional elements.

The relay controller 3001 serves to control the communications among the platforms 10. Specifically, the relay controller 3001 controls data transfer among the platforms 10 as illustrated in FIG. 4.

The failure detector 3002 detects a failure in the communications among the platforms 10, when it occurs. For example, the failure detector 3002 detects a failure when communications are not established within a given period.

The restart controller 3003 is an exemplary second restarter. The restart controller 3003 serves to restart the relay device 30 in response to detection of a communication failure by the failure detector 3002.

The message controller 3004 is an exemplary notifier. The message controller 3004 serves to notify the platforms 10-1 to 10-8 of the restart of the relay device 30. Specifically, the message controller 3004 transmits information representing the restart to the platforms 10-1 to 10-8 after completion of the restart of the relay device 30. For example, the message controller 3004 transmits a device readiness status (DRS) message to the platforms 10-1 to 10-8 during PCIe linkup.

The power supply control unit 40 will now be described.

The processor 41 of the power supply control unit 40 implements the functions illustrated in FIG. 5 by executing the programs stored in the memory 42, for example. Specifically, the processor 41 includes a power controller 4001, a restart detector 4002, and a status controller 4003 as functional elements.

The power controller 4001 serves to control power supply to the platforms 10. The power controller 4001 supplies power to the platforms 10 at the time of restart of the relay device 30.

The restart detector 4002 is an exemplary second detector. The restart detector 4002 detects the restart of the relay device 30. Specifically, the restart detector 4002 receives information representing the restart of the relay device 30 via the second connector 44. For example, the restart detector 4002 receives, via GPIO, a flag indicating the restart of the relay device 30 at the time of start-up of firmware (FW).

In response to receipt of a request for the information representing the restart of the relay device 30, the status controller 4003 transmits information indicating status change in the relay device 30 via the first connector 43. That is, in response to receiving a request for an error status indicating the restart of the relay device 30, the status controller 4003 transmits an error status as a response via the I2C.

The platforms 10-2 to 10-8 will now be described.

The processors 12-2 to 12-8 of the platforms 10-2 to 10-8 implement the functions illustrated in FIG. 5 by executing the programs stored in the memories 13-2 to 13-8 and the storages 14-2 to 14-8. Specifically, the processors 12-2 to 12-8 each include a communication controller 1021, a restart controller 1022, and an initialization controller 1023 as functional elements.

The communication controller 1021 is an exemplary second connector. The communication controller 1021 serves to control the root complexes 11-2 to 11-8 to communicate with the platforms 10 via the relay device 30. That is, the communication controller 1021 is connected to the relay device 30. The communication controller 1021 transmits and receives data to and from the relay device 30.

The restart controller 1022 is an exemplary first restarter. The restart controller 1022 serves to restart the platforms 10-2 to 10-8. Specifically, the restart controller 1022 causes the corresponding one of the platforms 10-2 to 10-8 to restart if a failure occurs therein.

Along with the restart of the platforms 10-2 to 10-8, the initialization controller 1023 initializes the platforms 10-2 to 10-8. Specifically, the initialization controller 1023 loads a driver. The initialization controller 1023 initializes registers such as BAR and allocates base addresses thereto.

The following will describe a recovery process. FIG. is a sequence diagram illustrating an exemplary recovery process in one or more embodiments. The recovery process refers to a process for recovering the communications among the platforms 10 via the relay device 30 from a communication failure.

The respective elements of the computer 1 with a built-in relay device are in a running state (Step S1).

The respective elements of the computer 1 with a built-in relay device establish communications thereamong via the relay device 30 (Step S2). For example, the communication controller 1011 of the platform 10-1 being a transmission source designates the platforms 10-2 to 10-8 to be a destination and transmits transmit data to the relay device 30. The relay controller 3001 of the processor 32 in the relay device 30 transmits the transmit data to the designated platforms 10-2 to 10-8. The communication controllers 1021 of the platforms 10-2 to 10-8 being a destination receive the transmit data.

A bus fault occurs in the failure detector 3002 of the processor 32. (Step S3). That is, the PCIe bus 36 of the failure detector 3002 has a communication failure.

The failure detector 3002 of the processor 32 transmits a bus transaction error to the platform 10-1 (Step S4). That is, the failure detector 3002 transmits thereto a notice that a communication error has occurred between the platforms 10.

The restart controller 3003 of the processor 32 restarts the relay device 30 (Step S5). The restart controller 3003 initializes various settings (Step S6).

After completion of the restart in Step S6, the restart controller 3003 of the processor 32 transmits a startup-completion notice (Step S7). Specifically, the restart controller 3003 validates a startup completion signal to transmit the startup-completion notice.

The message controller 3004 of the processor 32 sets a DRS message (Step S8). That is, the message controller 3004 generates information representing that the relay device 30 has restarted.

The restart detector 4002 of the power supply control unit 40 detects the restart of the processor 32 from the startup-completion notice (Step S9). The restart detector 4002 of the power supply control unit 40 transmits a detection notice indicating the restart of the processor 32 to the platforms 10-2 to 10-8 (Step S10).

The restart controller 3003 of the processor 32 ends transmitting the startup-completion notice (Step S11). Specifically, the restart controller 3003 invalidates the startup completion signal to end the transmission of the startup-completion notice.

The platform 10-1 and the relay device 30 are placed in PCIe link-up (Step S12). That is, the platform 10-1 and the relay device 30 are communicably connected to each other by PCIe.

The message controller 3004 of the processor 32 issues a DRS message (Step S13). That is, the message controller 3004 transmits information indicating the restart of the relay device 30 to the platform 10.

The connection detector 1012 of the platform 10-1 detects connection to the relay device 30 after completion of the restart of the processor 32 (Step S14).

The initialization controller 1013 of the platform 10-1 executes BIOS initialization (Step S15). That is, the initialization controller 1013 initializes registers and allocates base addresses thereto.

The initialization controller 1013 of the platform 10-1 initializes the driver (Step S16).

After detecting the restart of the processor 32, the restart controllers 1022 of the platforms 10-2 to 10-8 start a restart process of the corresponding platforms (Step S17). In response to an occurrence of communication failure in the corresponding platform, for example, the restart controller 1022 executes a restart process.

The restart controllers 1022 of the platforms 10-2 to 10-8 start up, following the restart in Step S3 (Step S18).

The initialization controllers 1023 of the platforms 10-2 to 10-8 load the driver (Step S19). The initialization controllers 1023 initialize registers (Step S20). That is, the initialization controllers 1023 allocate base addresses thereto.

The relay device 30 and the platforms 10-2 to 10-8 are placed in PCIe link-up (Step S21). That is, the platforms 10-2 to 10-8 and the relay device 30 are communicably connected to each other by PCIe.

The message controller 3004 of the processor 32 issues a DRS message (Step S22).

The respective elements of the computer 1 with a built-in relay device are in a running state (Step S23).

The status acquirer 1014 of the platform 10-1 issues an error status request (Step S24).

Responding to the error status request, the status controller 4003 of the power supply control unit 40 transmits an error status (Step S25).

As described above, the computer 1 with a built-in relay device according to one or more embodiments includes the platforms 10-1 to 10-8 communicably mutually connected via the relay device 30. Among the platforms 10-1 to 10-8, at least the platform 10-1 supports HPD. However, any of the platforms 10-2 to 10-8 does not support HPD. In such a case, in response to occurrence of a communication failure via the relay device 30 due to the restart of the platforms 10-2 to 10-8, the relay device 30 restarts itself. This is equivalent to a hot pluggable state of the connected platforms 10 and relay device 30. After detecting the restart of the relay device 30, the platform 10-1 initializes the settings relating to the communications established via the relay device 30, such as drivers and register values. Thereby, the computer 1 with a built-in relay device enables the platforms 10 to communicate with one another via the relay device 30 without restarting the platform 10-1. Thus, the computer 1 with a built-in relay device can continue the communications via the relay device 30.

The above embodiments have described PCIe as an example of bus (for example, expansion bus) or I/O interface for each element, however, the bus or I/O interface is not limited to PCIe. For example, the bus or I/O interface for each element may be a data transfer bus through which data is transferrable between the device (peripheral controller) and the processor. The data transfer bus may be a general-purpose bus through which data is transferrable at a higher speed in a local environment in one housing, such as one system or one device. The I/O interface may be either a parallel interface or a serial interface.

In the case of serial transfer, the I/O interface may be point-to-point connectable and able to transfer data on a packet basis. In the case of serial transfer, the I/O interface may have a plurality of lanes. The layer structure of the I/O interface may include a transaction layer for packet generation and decoding, a data link layer for error detection, and a physical layer for serial and parallel conversion. Further, the I/O interface may include a root complex of uppermost hierarchy with one or more ports, an endpoint serving as an I/O device, a switch for increasing the number of ports, and a bridge serving to convert a protocol. The I/O interface may use a multiplexer to multiplex transmit data and a clock signal for transmission. In this case, the receive side may use a demultiplexer to separate the data and the clock signal.

The information processing system of one or more embodiments can prevent the information processing devices from becoming non-communicable via the relay device.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing system comprising:
a first information processing device including a first connector that supports hot plugging representing insertion and removal at the time of power-on;
a plurality of second information processing devices; and
a relay device that communicably connects the first information processing device and the second information processing devices, wherein
the second information processing devices each comprise:
a second connector to be connected to the relay device, and
a first restarter that restarts the second information processing devices,
the relay device comprises:
a power supply control unit that supplies power to the first information processing device and the second information processing devices during restart of the relay device, and
a second restarter that restarts the relay device in response to detection of a communication failure, and
the first information processing device comprises:
the first connector to be connected to the relay device,
a first detector that detects the restarted relay device, and
an initializer that initializes settings relating to communications via the relay device in response to detection of the relay device by the first detector.

2. The information processing system according to claim 1, wherein the first information processing device further comprises:
a setting changer that changes, to a non-display setting, a display for switching connection and disconnection between the relay device, and the first information processing device and the second information processing devices.

3. The information processing system according to claim 1, wherein the relay device further comprises:
a notifier that notifies the first information processing device and the second information processing devices of the restart of the relay device.

4. The information processing system according to claim 1, wherein
the power supply control unit further comprises a second detector that detects the restart of the relay device, and
the first information processing device further comprises an acquirer that acquires information representing the restart of the relay device.
